(19) United States
(12) Patent Application Publication
(10) Pub. No.: US 2026/0185664 A1
(43) Pub. Date: Jul. 2, 2026

(54) METHOD FOR OPERATING A FUEL GAS TANK SYSTEM, AND A CONTROL DEVICE

(71) Applicant: Robert Bosch GmbH, Stuttgart (DE)

(72) Inventors: Christian Kuhnert, Vaihingen/Enz (DE); Christian Seibel, Stuttgart (DE); Markus Strasser, Stuttgart (DE); Sonny Tran, Stuttgart (DE); Stefan Kieferle, Stuttgart (DE)

(21) Appl. No.: 19/128,628

(22) PCT Filed: Oct. 17, 2023
(86) PCT No.: PCT/EP2023/078734

§ 371 Date: May 9, 2025

(30) Foreign Application Priority Data
Nov. 14, 2022 (DE) 10 2022 212 016.7

(51) Int. Cl. F17C 7/00; F17C 13/02; F17C 13/04

(52) U.S. Cl. CPC F17C 7/00; F17C 13/025; F17C 13/04; F17C 2201/0104; F17C 2205/0142; F17C 2205/0326; F17C 2221/012; F17C 2223/035; F17C 2250/03; F17C 2250/0434; F17C 2250/0636; F17C 2270/0184

(57) ABSTRACT

The invention relates to a method of operating a fuel gas tank system (1), comprising at least one fuel gas tank (2) for storing fuel gas at high pressure and a valve assembly (3) inserted into the fuel gas tank (2) for removing fuel gas from the fuel gas tank (2), wherein a shut-off valve (4) which is integrated downstream of a flow restrictor valve (5) in a removal path (6) of the valve assembly (3) in the direction of removal, which opens into a gas line (7), is actuated and opened to remove fuel gas. According to the present invention, before the shut-off valve (4) is actuated, a check is conducted in a step (a) to determine whether activation of the flow restrictor valve (5) is to be expected and, if the flow restrictor valve (5) is expected to be activated, the shut-off valve (4) is actuated several times in succession at certain time intervals in a step (b).

The invention furthermore relates to a control device for carrying out steps of the method.

### BACKGROUND

The invention relates to a method for operating a fuel gas tank system comprising at least one fuel gas tank for storing fuel gas at high pressure and a valve assembly inserted into the fuel gas tank for removing fuel gas from the fuel gas tank. The invention also relates to a control device for a fuel gas tank system.

Preferred areas of application are mobile fuel gas tank systems, in particular fuel cell and/or gas vehicles powered by a fuel gas. The fuel gas may in particular be hydrogen or natural gas that is stored in a fuel gas tank at high pressure.

Mobile fuel gas tank systems having at least one fuel gas tank for storing fuel gas, for example hydrogen or natural gas, are known. The fuel gas tank is typically configured as a high-pressure tank. A high pressure tank always requires a shut-off valve to tightly shut off the tank when the vehicle is not in service. For safety reasons, the shut-off valve is generally embodied as a valve which is closed when no current is present. To provide further protection, a flow restrictor valve may be connected upstream of the shut-off valve which, in the event of damage, highly restricts the flow and thus allows for a controlled discharge of fuel gas from the fuel gas tank.

The shut-off valve and the flow restrictor valve are typically integrated into a valve assembly that can be inserted into the fuel gas tank as a compact unit, particularly in the area of a bottleneck of the fuel gas tank. This is integrated into a removal path of the valve assembly that opens into a gas line. In addition to the shut-off valve and the flow restrictor valve, other components, in particular further valves, are generally integrated into the removal path.

As the number of components in the removal path increases, the pressure drop increases during removal of fuel gas from the fuel gas tank. The pressure threshold for activating the flow restrictor valve, hereinafter referred to as the activation threshold, must therefore be lower than the differential pressure across the entire valve assembly. Thus, when the shut-off valve is activated, the risk that the flow restrictor valve will be inadvertently activated and the flow through the open shut-off valve will be limited increases. The risk exists in particular in the case of an increase in pressure in the fuel gas tank and/or a decrease in pressure in the gas line, so that the difference between the pressure in the fuel gas tank and the pressure in the gas line is particularly high. If the flow restrictor valve is activated, the flow is limited so that the requested amount of fuel gas cannot be withdrawn from the fuel gas tank. In a fuel gas tank system with multiple fuel gas tanks, this results in the missing amount being withdrawn from a fuel gas tank where activation of the flow restrictor valve is least expected. Consequently, uneven depletion of the plurality of fuel gas tanks may occur as a result.

### SUMMARY

The present invention relates to the task of preventing a limitation of the flow due to an activated flow restrictor valve when removing fuel gas from a fuel gas tank or at least alleviating the negative consequences of such a limitation of the flow. In order to solve this problem, the method according to the disclosure is proposed. Advantageous embodiments of the invention can be gathered from the dependent claims. A control device for carrying out steps of the method according to the invention is also specified.

A method of operating a fuel gas tank system comprising at least one fuel gas tank for storing fuel gas at high pressure and a valve assembly inserted into the fuel gas tank for removing fuel gas from the fuel gas tank is proposed. In the method, a shut-off valve that is integrated into a removal path of the valve assembly that opens into a gas line in the direction of removal downstream of a flow restrictor valve is actuated and opened in order to remove fuel gas. According to the present invention, prior to actuating the shut-off valve, a check is conducted in a step (a) to determine whether activation of the flow restrictor valve is to be expected. If activation of the flow restrictor valve is expected, the shut-off valve is actuated several times in succession at certain time intervals in a step (b).

By actuating the shut-off valve several times, the shut-off valve is opened multiple times in succession. The shut-off valve is closed between two opening phases so that no fuel gas is removed from the fuel gas tank. That is, between two opening phases, the high flow through the flow restrictor valve and thereby activation of the flow restrictor valve is stopped. As a result, the flow restrictor valve opens again so that the shut-off valve can be activated or opened again to remove fuel gas. If the flow restrictor valve is activated repeatedly, actuation of the shut-off valve is interrupted again until activation of the flow restrictor valve is ended and fuel gas removal from the fuel gas tank can continue.

The proposed actuation strategy prevents flow limitation due to unintended activation of the flow restrictor valve. If the flow restrictor valve is already activated, the flow limitation can be quickly reversed using the proposed actuation strategy, so that fuel gas can be removed from the fuel gas tank even in unfavorable pressure conditions. Thus, in mobile fuel gas tank systems, system availability and therefore the full range of the vehicle is restored. In fuel gas tank systems with multiple fuel gas tanks, uneven depletion of the fuel gas tanks may be prevented using the proposed actuation strategy.

The proposed actuation strategy results in reduced requirements for the valve assembly inserted into the fuel gas tank. Accordingly, the design of the valve assembly is simplified.

Preferably, the current pressure in the fuel gas tank and/or the current pressure in the gas line is sensed using sensors in order to conduct the check in step (a). In certain cases, it is possible to assess whether activation of the flow restrictor valve is to be expected based on the current pressure in the fuel gas tank or the current pressure in the gas line.

Such a case may exist, for example, when the fuel gas tank has been exposed to solar radiation for an extended period of time with the vehicle off, such that heating results in a noticeably high pressure increase in the fuel gas tank. This can be sensed using sensors and, if necessary, compared with a maximum pressure value which is normally reached. A significantly higher value in this case indicates an expected activation of the flow restrictor valve when the shut-off valve is actuated, even without information on the current pressure in the gas line.

Furthermore, such a case may exist if the gas line has a leak, such that there is a noticeably high pressure drop in the gas line. This can also be sensed using sensors and, if necessary, compared with a minimum pressure value which is normally reached. A significantly lower value in this case, in turn, indicates an expected activation of the flow restrictor valve when the shut-off valve is actuated. Knowledge of the current pressure in the fuel gas tank is not required for this purpose.

Sensory detection of the pressure in the fuel gas tank and in the gas line requires appropriate sensory technology. However, a fuel gas tank is not always equipped with corresponding sensor technology, in particular a tank pressure sensor. Alternatively or in addition, it is therefore suggested that the pressure in the fuel gas tank be determined based on a further parameter, in particular the temperature. The pressure in the fuel gas tank may then be estimated based on the temperature profile.

For example, in the absence of a tank pressure sensor, the temperature in the fuel gas tank and the pressure in the gas line may be sensed and stored before the vehicle is stopped and before the shut-off valve is closed. Before the vehicle is restarted, the temperature in the fuel gas tank is then repeatedly sensed using sensors so that the expected pressure in the fuel gas tank can be calculated, taking into account the change in temperature during the shutdown phase and the pressure in the gas line, according to the following formula:

$$p 2 = p 1 \times T 2 / T 1$$

$$with$$

$$p 1 = the pressure in the gas line before shutting off$$

$$p 2 = the current pressure in the fuel gas tank$$

$$T 1 = the temperature in the fuel gas tank before shutting off$$

$$T 2 = the current temperature in the fuel gas tank$$

In the further development of the invention, it is proposed that the differential pressure, that is, the difference between the pressure in the fuel gas tank and the pressure in the gas line, is determined using the valve assembly for the check in step (a). The following formula may be used for this purpose:

$$dp = p 2 - p 3$$

$$with$$

$$p 2 = the current pressure in the fuel gas tank$$

$$p 3 = the current pressure in the gas line$$

It is possible to check very precisely whether activation of the flow restrictor valve is to be expected when the shut-off valve is actuated and opened based on the differential pressure determined prior to actuation of the shut-off valve. This is because the higher the differential pressure is, the greater the flow through the flow restrictor valve is, and thus the higher the risk is of unintended activation of the flow restrictor valve, resulting in flow limitation.

Furthermore, it is proposed that after actuation of the shut-off valve in step (b), the actuation of the shut-off valve is interrupted until activation of the flow restrictor valve has ended. That is, the shut-off valve is not re-opened until the flow is no longer restricted. This ensures that fuel gas can again be withdrawn from the fuel gas tank, at least until the flow restrictor valve is activated once again. This is because the flow restrictor valve is activated with a certain delay. Due to this delay, there is already some pressure equalization between the pressure in the fuel gas tank and the pressure in the gas line, so that further activation of the flow restrictor valve can be avoided if possible.

Preferably, therefore, the interval between two actuation phases for opening the shut-off valve is selected as a function of the reaction time of the flow restrictor valve.

Further preferably, the differential pressure is determined via the valve assembly prior to each actuation of the shut-off valve in step (b). This procedure has the advantage that the actuation strategy can be adjusted to the differential pressure currently determined (“dynamic actuation strategy”), in particular with regard to the duration of activation and/or the duration of actuation interruption. Pressure equalization between the pressure in the fuel gas tank and the pressure in the gas line may be accelerated in this manner.

Preferably, the frequency of actuation of the shut-off valve and/or the interruptions is determined dependent on the differential pressure across the valve assembly prior to the first actuation.

According to a preferred embodiment of the invention, a flow restrictor valve activation threshold is determined, and the fuel gas removal shut-off valve is actuated only when the activation threshold is not met, preferably in consideration of a safety margin. This measure ensures that flow limitation does not occur.

A corresponding consideration of the activation threshold of the flow restrictor valve is particularly useful in fuel gas tank systems with multiple fuel gas tanks. In this case, the requested amount of fuel gas can be taken from another fuel gas tank, provided that it is ensured that activation of the flow restrictor valve is not expected upon actuation of the shut-off valve. Preferably, therefore, the fuel gas is withdrawn from the fuel gas tank where the lowest pressure prevails. The removal of fuel gas results in a pressure increase in the gas line, so that some pressure equalization is achieved between the pressure in the gas line and the tank pressure of the other respective fuel gas tanks. As pressure equalization progresses, the shut-off valves of the other fuel gas tanks may then be actuated and opened so that they are evenly depleted.

Furthermore, it is proposed that a deactivation threshold is determined for the flow restrictor valve and that the shut-off valve is not actuated again until the pressure falls below a deactivation threshold after actuation is interrupted. This measure ensures that the flow limitation is reversed before the shut-off valve is actuated or opened again.

In order to solve the task mentioned at the beginning, a control device for a fuel gas tank system is also proposed which is set up to carry out steps of a method according to the invention. The control device may be used to determine the timing and frequency of actuation of a shut-off valve. An activation threshold and/or a deactivation threshold of a flow restrictor valve can be stored in the control device for this purpose. In a fuel gas tank system with multiple fuel gas tanks, the order of actuation of the shut-off valves may be determined depending on the tank-specific determined differential pressures.

### BRIEF DESCRIPTION OF THE DRAWINGS

The method according to the invention and its advantages are explained in more detail below with reference to the accompanying drawings. Shown are:

FIG. 1 a schematic illustration of a fuel gas tank system which can be operated according to the method according to the invention,

FIG. 2 a schematic longitudinal section through a valve assembly of a fuel gas tank of the fuel gas tank system of FIG. 1; and

FIG. 3 a diagram illustrating the actuation of the shut-off valve integrated into the valve assembly of FIG. 2 as a function of the differential pressure (dp) between the fuel gas tank and gas line.

### DETAILED DESCRIPTION

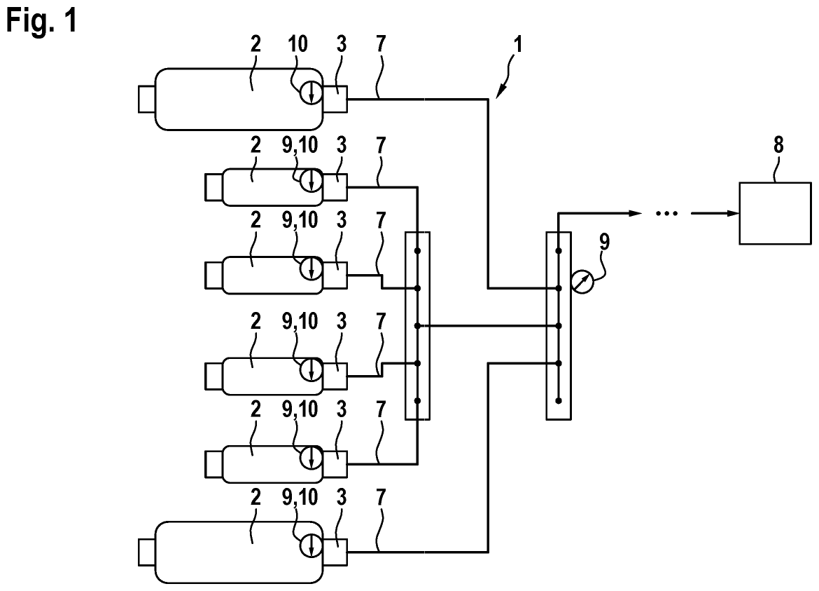

FIG. 1 shows a simplified illustration of a fuel gas tank system 1 with a plurality of fuel gas tanks 2. The fuel gas tank system 1 shown serves to supply a fuel cell stack 8 with fuel gas, preferably hydrogen.

A valve assembly 3 is inserted into each fuel gas tank 2, via which the respective fuel gas tank 2 is connected to a gas line 7. The gas lines 7 are merged so that the pressure is substantially the same in the gas lines 7. This is measured using a pressure sensor 9. A further pressure sensor 9 is integrated in each fuel gas tank 2. Instead of a pressure sensor 9, only a temperature sensor 10 can be provided in each fuel gas tank 2.

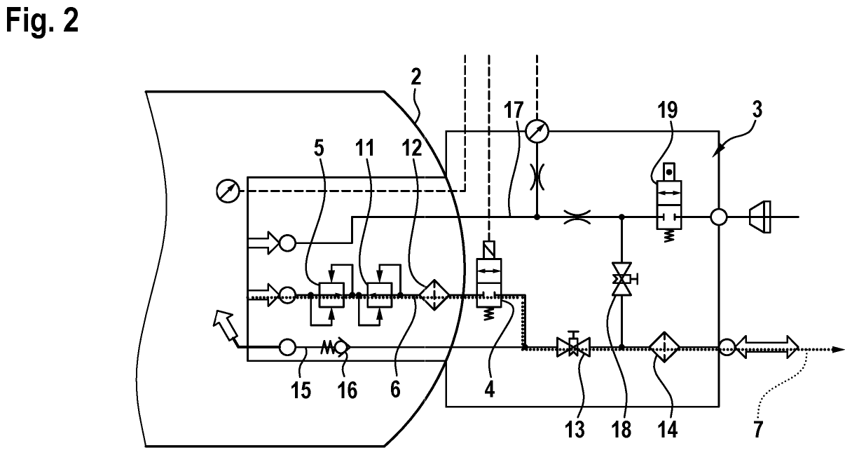

FIG. 2 shows an enlarged diagram of a valve assembly 3 of a fuel gas tank 2. A removal path 6 leads through the valve assembly 3, which opens into the gas line 7. A shut-off valve 4 as well as—in the direction of removal upstream of the shut-off valve 4—a flow restrictor valve 5 are integrated into the removal path 6. A further flow restrictor valve 11 for restricting the flow in the opposite flow direction and a filter 12 are disposed between the flow restrictor valve 5 and the shut-off valve 4. A manually actuatable valve 13 and a further filter 14 are also integrated downstream of the shut-off valve 4.

A fueling path 15 branches off from the removal path 6 in the direction of removal downstream of the shut-off valve 4. The direction of flow in the fueling path 15 is determined by an integrated check valve 16. In this way, the check valve 16 prevents fuel gas from flowing out of the fuel gas tank 2 via the fueling path 15.

The valve assembly 3 shown in FIG. 2 also has a discharge path 17 in which further valves 18, 19 are disposed. Firstly, a further manually actuatable valve 18 is provided, which passes all valves and is also referred to as a “bleed valve”. The valve 19 is a safety valve for reducing any excess pressure.

Essential components for carrying out the method according to the invention are the shut-off valve 4 shown in FIG. 2 and the upstream flow restrictor valve 5. The further illustrated components are optional and not absolutely necessary for the performance of the method according to the invention.

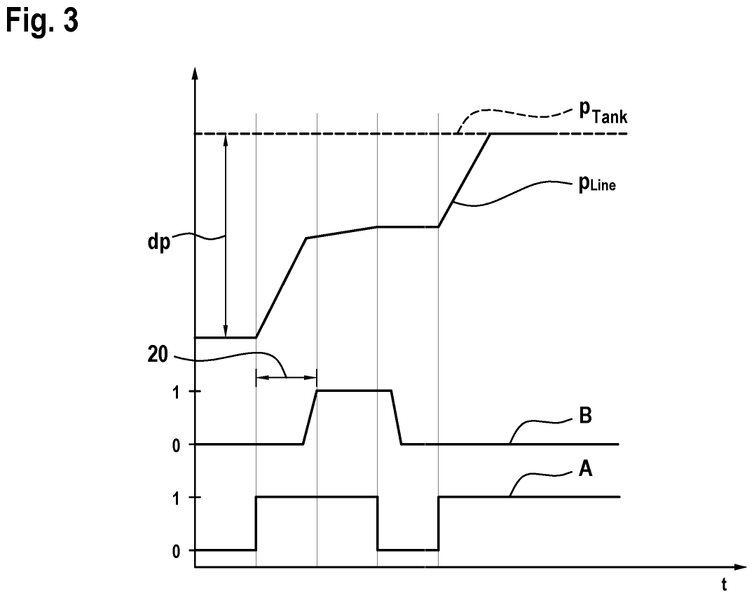

The method according to the invention is explained hereinafter with reference to FIG. 3.

With the shut-off valve 4 initially still closed (see curve A), there a pressure p_{Tank} prevails in the fuel gas tank 2 and a pressure p_{Line} prevails in the gas line 7 that is significantly below the pressure p_{Tank}, so that a differential pressure dp results. If the shut-off valve 4 is now actuated to open it (see curve A), the fuel gas flows from the fuel gas tank 2 into the gas line 7 so that the pressure p_{Line} rises sharply. That is, the flow through the shut-off valve 4 and the flow restrictor valve 5 is very great. This causes the flow restrictor valve 5 to activate (see curve B) with some delay (see arrow 20) so that the flow is limited. The pressure p_{Line} in the gas line 7 therefore only increases slightly. To quickly reverse the flow restriction, the actuation of the shut-off valve 4 is interrupted (see curve A) so that the flow is completely blocked and the pressure p_{Line} in the gas line 7 does not increase further. This ultimately leads to the deactivation of the flow restrictor valve 5, so that the shut-off valve 4 can be actuated and opened again subsequently until a pressure equalization is achieved between the pressure p_{Tank} and the pressure p_{Line}.

If the flow restrictor valve 5 is activated again during the course of the pressure equalization, the actuation of the shut-off valve 4 can be interrupted once again.

1. A method for operating a fuel gas tank system (1), comprising at least one fuel gas tank (2) for storing fuel gas at a high pressure and a valve assembly (3) inserted into the fuel gas tank (2) for removing fuel gas from the fuel gas tank (2), wherein a shut-off valve (4) integrated downstream of a flow restrictor valve (5) in a removal path (6) of the valve assembly (3) in the direction of removal, which opens into a gas line (7), is actuated and opened to remove fuel gas,
wherein, prior to actuating the shut-off valve (4), a check is conducted in a step (a) to determine whether activation of the flow restrictor valve (5) is to be expected and, if the flow restrictor valve (5) is expected to be activated, the shut-off valve (4) is actuated several times in succession at certain time intervals in a step (b).

2. The method according to claim 1,
wherein the current pressure (p_{Tank}) in the fuel gas tank (2) and/or the current pressure (p_{Line}) in the gas line (7) is sensed using sensors in order to conduct the check in step (a).

3. The method according to claim 2,
wherein the current pressure (p_{Tank}) in the fuel gas tank (2) is determined based on a temperature.

4. The method according to claim 2,
wherein the current differential pressure (dp), that is the difference between the pressure (p_{Tank}) in the fuel gas tank (2) and the pressure (p_{Line}) in the gas line (7), is determined via the valve assembly (3) for the check in step (a).

5. The method according to claim 1,
wherein after the shut-off valve (4) is actuated in step (b), the actuation of the shut-off valve (4) is interrupted until activation of the flow restrictor valve (5) ends.

6. The method according to claim 1,
wherein the differential pressure (dp) is determined via the valve assembly (3) in step (b) before each actuation of the shut-off valve (4).

7. The method according to claim 6,
wherein the frequency of actuation of the shut-off valve (4) and/or the interruptions is determined via the valve assembly (3) depending on the differential pressure (dp) prior to the initial actuation.

8. The method according to claim 1,
wherein an activation threshold (dp_{Active}) of the flow restrictor valve (5) is determined and the shut-off valve (4) is actuated for the removal of fuel gas only if the level falls below the activation threshold (dp_{Active}).

9. The method according to claim 1,
wherein a deactivation threshold (dp_{Deactive}) of the flow restrictor valve (5) is determined and the shut-off valve (4) is actuated again after an interruption of the actuation only if the level falls below the deactivation threshold (dp_{Deactive}).

10. A control device for a fuel gas tank system (1) which is configured to carry out steps of a method according to claim 1.
